(19) United States
(12) Patent Application Publication
(10) Pub. No.: US 2005/0279937 A1
(43) Pub. Date: Dec. 22, 2005

(54) Scanning electron microscope and similar apparatus

(76) Inventors: Hirotami Koike, Tokyo (JP); Shinichi Okada, Tokyo (JP)

Correspondence Address: KUBOVCIK & KUBOVCIK, SUITE 710, 900 17TH STREET NW, WASHINGTON, DC, 20006, US

(21) Appl. No.: 11/106,707

(22) Filed: Apr. 15, 2005

(30) Foreign Application Priority Data
Jun. 21, 2004 (JP) 2004-182378

(51) Int. Cl. G01N 23/00

(52) U.S. Cl. 250/310

(57) ABSTRACT

To provide a scanning electron microscope that can detect with high efficiency the secondary electrons generated from the entire surface of a target, in a scanning electron microscope with an objective lens having a retarding electric field near a sample, at least two detectors are arranged with axial symmetry to electron optical axis, a target that causes secondary electrons or reflected electrons to collide with the target is disposed near the detectors, and at least one electrode member having a negative potential lower than a potential of the target is formed almost with axial symmetry to the electron optical axis.

### BACKGROUND OF THE INVENTION

The present invention relates to a scanning electron microscope equipped with an objective lens having a retarding electric field in the neighborhood of a sample, and with detectors for detecting the secondary electrons generated from the sample, or for detecting reflected electrons. The invention also relates to an exposure system, mask inspection system, or electron-beam lithographic system, and other similar apparatus used with semiconductor-manufacturing apparatus.

With the micro-structuring of semiconductors, ultrafine image-resolving technology such as OPC (Optical Proximity Correction) has come to be adopted, which is increasing the importance of mask inspection and of related transfer resist pattern inspection based on two-dimensional images. For this reason, lithographic simulators are used. However, differences occur between actual transfer patterns and simulation-based images, and eventually, transfer resist pattern inspection with two-dimensional images becomes necessary.

In such a case, to allow for the throughput achieved with high resolution, a field-of-view as wide as possible needs to be inspected using high-resolution probes. To obtain a wider field-of-view, a deflection system with greater power is required and necessarily, the secondary electrons that have been generated from the sample are also deflected significantly. For these reasons, to detect the secondary electrons, the need has arisen to use targets having a wider area, and the secondary electrons generated from the entire surface of a target have become difficult to detect with one detector.

Hence, Japanese Patent Laid-open No. 10-214586 (hereinafter, JP 10-214586) proposes a method in which secondary electrons from a target as wide as possible are focused by arranging only a plurality of, for example, two to four detectors at positions symmetrical with respect to an optical axis. This method, however, causes the following inconvenience. That is to say, since secondary electrons from a sample have an energy level of 2 to 7 eV, when detectors are arranged symmetrically with respect to the optical axis, the electric fields stemming from the detectors, near the optical axis, may be canceled. As shown in FIG. 5, therefore, secondary electrons 3, 4 from the vicinity of electron optical axis O of a scanning electron microscope 10 may be reflected by a target 1, resulting in the electrons escaping downward without being focused on detectors 2 to cause the deterioration of detection efficiency. The actual collection ratio of electrons in the example of the figure was about 30%.

Also, Non-patent document 1 (“Improved CD-SEM Optics with Retarding and Boosting Electric Fields” (Part of the SPIE Conference on Metrology, Inspection, and Process Control for Microlithography XIII, Santa Clara, Calif., March 1999, SPIE Vol. 3677)), shows a scanning electron microscope using an [E×B] filter as a first conventional example. In this example, a retarding electric field and a boosting electrode member are provided and a meshed structure is disposed at a forward position of detectors.

A second conventional example uses a sample having a grounding potential, as described in Non-patent document 2 (“Critical-Dimension Measurement SEM OPAL 7830i” (Proceedings of the Symposium on LSI Testing, Jul. 7-8, 1996, p. 36 etc.)), in which an accelerating electrode member is directly above the sample and detectors also have a plus potential close to that of the accelerating electrode member.

In a third example, as described in Japanese Patent Laid-open No. 10-294074 (hereinafter JP 1-294074), when an accelerating electric field for secondary electrons is present near the sample, since the secondary electrons generated therefrom will be accelerated at a high energy level and will become difficult to focus on a detector disposed outside an optical axis. In the third example, therefore, electrons are caused to once collide with a target disposed on a surface almost above the detector perpendicularly to the axis, and the secondary electrons generated from the target at an energy level of 2 to 7 eV are detected by the detector via an [E×B] filter That is to say, the secondary electrons that have been generated from the target position set in the opposite direction of the detector are deflected in the direction thereof by the electric field and magnetic field of an [E×B] filter and detected by one detector.

Incidentally, conventional critical-dimension measurement scanning electron microscopes (CD-SEMs) have been able to exhibit satisfactory performance since their field sizes were as small as 20 to 50 μm and since the targets used were also as thin as about 20 mm. However, the following problem has occurred. Increasing the field size to a 300 μm˜1 mm range for improved inspection throughput also makes it necessary to increase the thickness of the target. Therefore, the secondary electrons generated from the entire field cannot be effectively detected with one detector.

Additionally, since detectors generally have a potential of +10 kV, the electric field of the detector used may affect incident electrons, leading to axial misalignment or the occurrence of astigmatism.

As shown in the above mentioned document non-patent document 1 and the JP 10-294074, therefore, for improved focusing of the secondary electrons generated from the target, the electric field of the detector is shielded by disposing a meshed structure in front of the detector and by passing the electrons through the apertures in the meshed structure. These methods, however, have posed another problem in that the presence of the meshed structure deteriorates detection efficiency.

In the above mentioned document Non-patent document 2, although a configuration with a semiconductor detector or a multichannel plate placed at the target is also proposed, the use of the semiconductor detector has presented problems associated with high-speed scanning and noise. The use of the multichannel plate has had problems associated with high-speed image detection since signals remain astray at a potential of 1,500 V. In addition, the use of the multichannel plate has had the problem in that the possible deterioration of the secondary-electron multiplier surface due to contamination thereof makes the multichannel plate unable to withstand a long period of use.

Furthermore, in the example of JP 10-294074, although the target uses a scintillator and the light emitted from the scintillator is also detected, there is the further problem in that operating conditions are limited. The reason for this is that since the light emitted from the target assumes an accelerating voltage of at least 10 kV, the sample also assumes a potential of about 10 kV and thus the use of the scintillator takes effective only when the energy level of the electrons impinging on the target is about 10 kV.

In short, none of the foregoing conventional examples suits the intended purpose of wide-field high-speed scanning.

It is therefore an object of the present invention is to provide a scanning electron microscope capable of guiding to a detector very efficiently the secondary electrons bounced back from the entire target surface, and detecting the electrons.

It is another object of the invention to provide apparatus similar to the above microscope.

### SUMMARY OF THE INVENTION

In order to solve the above problems, the present invention is a scanning electron microscope and similar apparatus each characterized by including: an objective lens disposed near a sample, and formed with a retarding electric field; at least two detectors disposed with substantially axial symmetry with respect to an electron optical axis; a target disposed near the detectors in order to cause secondary electrons or reflected electrons to collide with the target; and an electrode member disposed downstream with respect to the target, the electrode member being impressed with a negative potential lower than a surface potential of the target and formed with substantially axial symmetry with respect to the electron optical axis.

In another aspect of the invention, it is characterized in that the scanning electron microscope and similar apparatus are each constructed so that the surface potential of the target is also maintained at a negative value.

In another aspect of the invention, it is characterized in that in the scanning electron microscope and similar apparatus, each of the detectors has a cap of a 5-to-20-mm diameter to acquire secondary electrons or reflected electrons.

In more another aspect of the invention, it is characterized in that the scanning electron microscope and similar apparatus each further have an additional detector above the detectors arranged with axial symmetry.

In more another aspect of the invention, it is characterized in that the scanning electron microscope and similar apparatus each have a static electromagnetic field objective lens structure that maintains the sample at a negative potential and includes the objective lens functioning as the retarding electric field.

In more another aspect of the invention, it is characterized in that the scanning electron microscope and similar apparatus are each constructed so as to have an electrode disposed near the sample so as to accelerate secondary electrons, the sample being set to assume grounding potential.

According to the present invention, the secondary electrons that have been generated from the entire surface of a target can be guided to detectors through the electric field of an electrode member and detected with high efficiency.

### BRIEF DESCRIPTION OF THE DRAWINGS

FIG. 1 is a sectional view showing a first embodiment of a scanning electron microscope according to the present invention.

FIG. 2 is a sectional view showing a second embodiment of a scanning electron microscope according to the present invention.

FIG. 3 is a plan view showing a third embodiment of a scanning electron microscope according to the present invention.

FIG. 4 is a sectional view showing a fourth embodiment of a scanning electron microscope according to the present invention.

FIG. 5 is a sectional view showing a collection state of secondary electrons in the scanning electron microscope according to a conventional example.

### DETAILED DESCRIPTION OF THE PREFERRED EMBODIMENTS

The best embodiments of the present invention will be described hereunder.

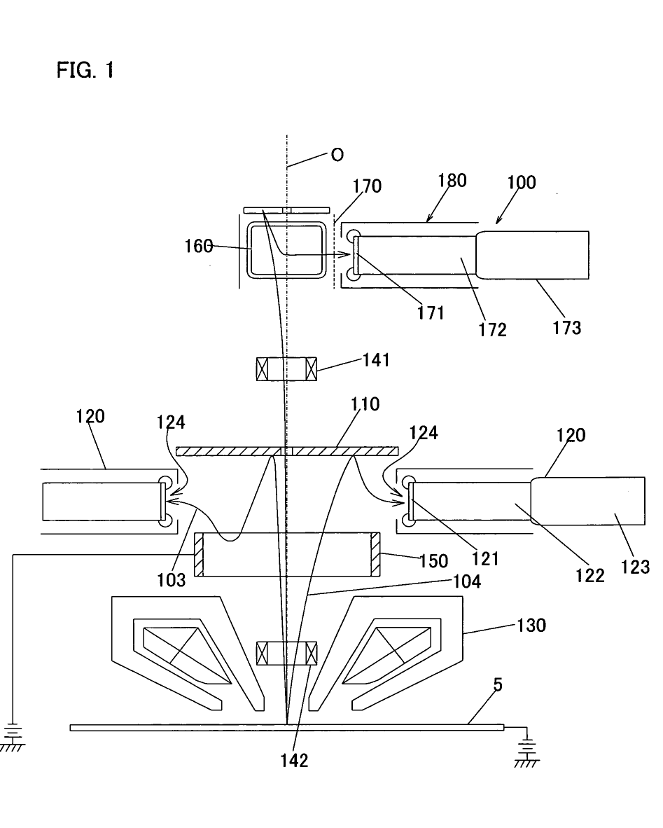

FIG. 1 is a sectional view showing a first embodiment of a scanning electron microscope according to the present invention. In the present embodiment, an electrode member 150 of a negative potential is disposed under a target 110 so that secondary electrons 103, 104 from the vicinity of an optical axis O of the electron beams directed onto a sample 5 may be repelled and effectively guided to detectors 120. That is to say, a scanning electron microscope 100 of the present embodiment includes the target 110 for reflecting the secondary electrons and the like, detectors 120, 180 arranged in a dual-stage fashion to detect the secondary electrons and the like, an objective lens 130 formed with a retarding electric field, and two deflecting coils 141, 142. The detector 120 is constructed of a scintillator 121, a light guide 122, and a photomultiplier tube (PMT) 123. Similarly, the detector 180 is constructed of a scintillator 171, a light guide 172, and a photomultiplier tube (PMT) 173. It is desirable that the detectors 120, 180 should have a 5-to-20-mm diameter holed section (cap) through which the secondary beams and the like enter. The electrode member 150 is disposed between the objective lens 130 and the detector 120, at a position downstream of the target 110. The electrode 150 has a negative potential maintained below a potential of the target 110. In addition, the electrode member 150 has an incident electron beam passage hole 111 near the optical axis O of the electron beams, and is constructed as a member formed with substantial symmetry to the optical axis O. Of course, the electrode member may be constituted by multiple electrode pieces.

A negative voltage from, for example, −50 V to −10 V is applied to the electrode member 150. The target 110 is grounded or impressed with a negative voltage of about −3 V. Above the incident-beam passage hole 111 of the target 110, an [E×B] filter 160 and the detector 180 are arranged and a meshed structure 170 for shielding an electric field of the detector 180 is further disposed.

In the scanning electron microscope 100 of the present invention, after being reflected by the target 110, the secondary electrons 103, 104 that have been generated from the sample along the optical axis O are repelled by the negative potential of the electrode member 150 and reliably collected by the detectors 120. In particular, even the secondary electrons 103 generated near the optical axis O are bounced back from the target 110 and after being repelled by the electrode member 150, reliably collected by the detectors 120.

That is to say, the secondary electrons 103, 104 generated from the sample are enclosed by the target 110 and the electrode member 150 and then reliably collected by the detectors 120 impressed with a positive potential (e.g., +10 kV). The secondary electrons can thus be detected with high efficiency.

Also, the secondary electrons that have been generated from the sample along the optical axis O are passed through the incident-beam passage hole 111 in the target 110 and reliably collected by the detector 180 via the [E×B] filter 160.

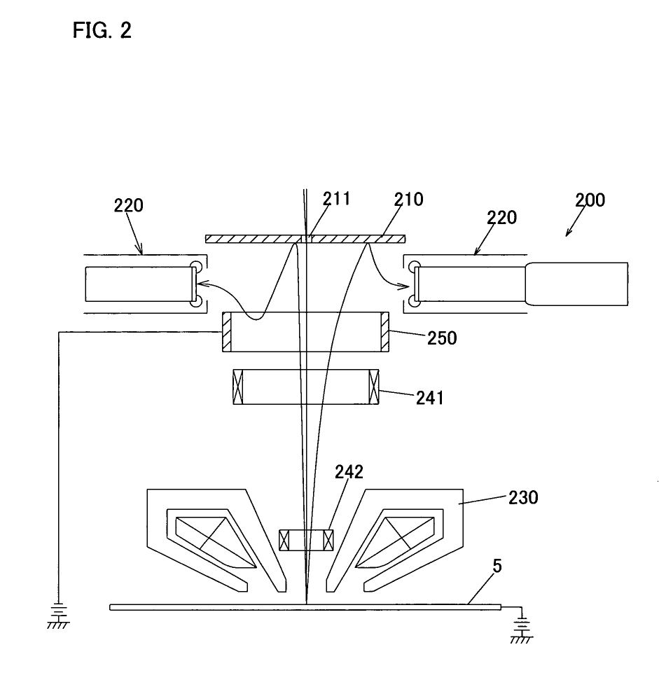

FIG. 2 is a sectional view showing a second embodiment of a scanning electron microscope according to the present invention. A scanning electron microscope 200 according to the present embodiment includes a target 210, detectors 220, an objective lens 230, deflectors 241, 242, and an electrode member 250. The present embodiment differs from the first embodiment in that the target 210 has a sufficiently small incident-beam passage hole 211 (e.g., 0.5 to 1.0 mm in diameter) and in that an upstream detector is not provided. In this embodiment, compared with the target in the first example, the target 210 is disposed at a further upstream position. The upstream deflector 241 is disposed under the target and the downstream deflector 242 is disposed inside the objective lens 230.

In the present embodiment, meshed structures for shielding electric fields of the detector 220 may also be provided in front thereof. In addition, the number of detectors may be four or more, not two or three. In the present embodiment, the electrode member 150 is constructed so that it takes a negative potential lower (but, greater in absolute value) than a potential of the target 210 in order to minimize effects of a landing voltage.

The semiconductor electron detector with eightfold symmetry, manufactured by Opal, Inc., takes a configuration different in the presence of a target. This electron detector has problems associated with its response speed, and is therefore valid only for use as a scintillator detector. The target must have, on its surface, a hole usually from 1 to 4 mm in diameter, to allow incident electrons to pass through.

Also, for the [E×B] filter, conditions for focusing secondary electrons at the target vary significantly with the landing voltage used, and at specific landing voltages, all secondary electrons from the sample are focused on and passed through the hole in the target. Detection efficiency substantially decreases as a result. However, even when the [E×B] filter is used, the problem of detection efficiency decreasing can be solved by reducing the diameter of the incident-beam passage hole 211 in the target 210 to 1-2 mm.

According to the second embodiment, a collection ratio of secondary electrons and the like can also be enhanced in the scanning electron microscope having a single-stage arrangement of detectors.

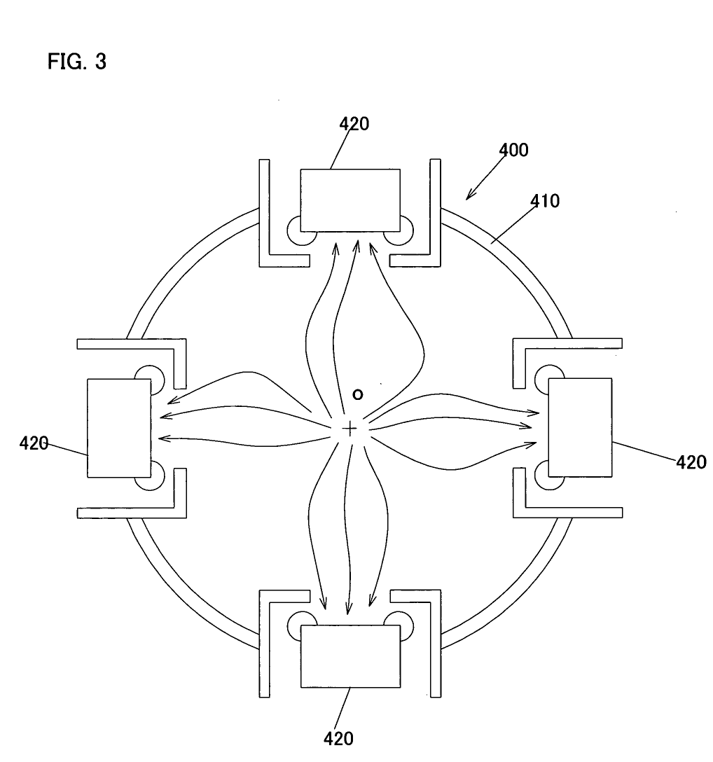

FIG. 3 is a plan view showing a third embodiment of a scanning electron microscope according to the present invention. A scanning electron microscope 400 according to the present embodiment has four detectors 420 each disposed at a 90°-shifted position around an electron beam optical axis O, and an electrode member (not shown) is disposed for each detector 420.

The scanning electron microscope 400 according to the present embodiment also operates similarly to the first example. As shown with arrows in FIG. 3, the secondary electrons that have been generated from a sample along the optical axis O are re-converted into secondary electrons at a target (not shown) and then after being repelled by a negative potential of each electrode member (not shown), reliably collected by the detectors 420.

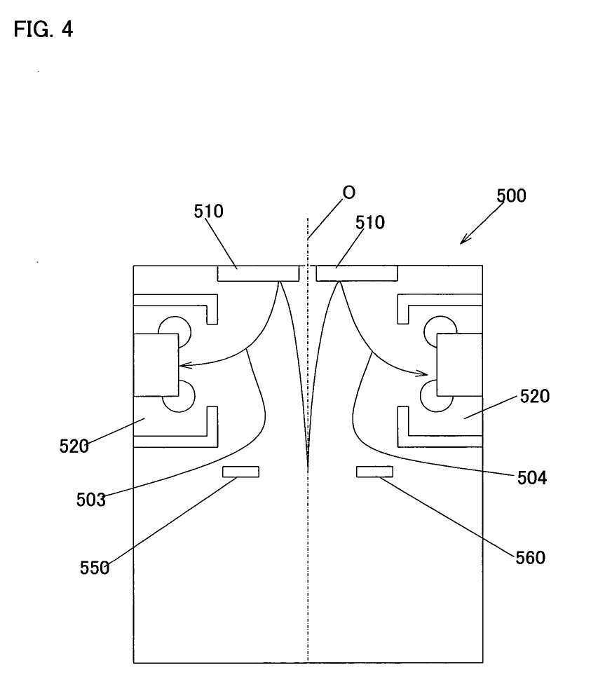

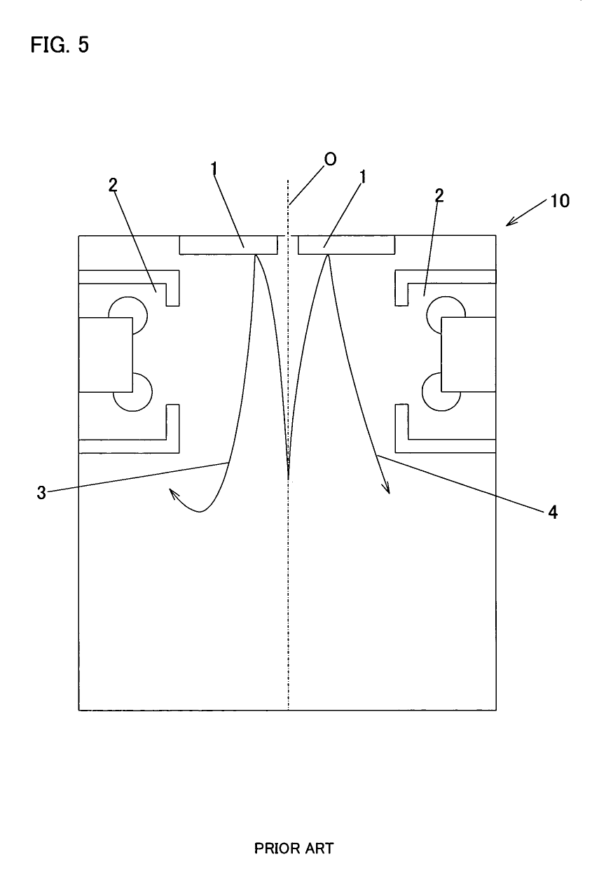

FIG. 4 is a sectional view showing a fourth embodiment of a scanning electron microscope according to the present invention. A scanning electron microscope 500 according to the present embodiment has two electrode members 550 in addition to the conventional scanning electron microscope configuration shown in FIG. 5. Reference numerals 510, 510 and 520, 520 in FIG. 5 denote targets and detectors, respectively. Reference numerals 1, 1 and 2, 2 in FIG. 5 denote targets and detectors, respectively, and 3, 4 denote secondary electrons.

Secondary electrons 503, 504 can be collected with an efficiency essentially of 100% by providing the electrode members 550, 550 and applying voltages of −10 V to the targets 510, 510 located upstream, and −100 V to the electrode members 550, 550 located downstream.

The configuration of the scanning electron microscope is not limited to the specific examples described above, and the kinds of particles detected are not limited to secondary electrons, either, and may be charged particles such as reflected electrons. In addition, if two or more detectors are arranged with axial symmetry to an electron optical axis, a target is disposed near the detectors so that secondary electrons, reflected electrons, or other charged particles collide with the target, and an electrode member to be impressed with a negative potential lower than a surface potential of the target is formed downstream with respect thereto and with almost axial symmetry to the electron optical axis, it is possible to repel from the electrode member the charged particles generated from the entire target surface, such as secondary electrons or reflected electrons, and collect these particles into the detectors reliably with high efficiency. This is possible, even for the exposure system, mask inspection system, electron-beam lithographic system, and other similar types of apparatus other than the scanning electron microscope that are used with semiconductor-manufacturing apparatus.

1. A scanning electron microscope and similar apparatus, comprising:
an objective lens disposed near a sample, and formed with a retarding electric field;
at least two detectors disposed with substantially axial symmetry with respect to an electron optical axis;
a target disposed near said detectors in order to cause secondary electrons or reflected electrons to collide with said target; and
an electrode member disposed downstream with respect to said target, said electrode member being impressed with a negative potential lower than a surface potential of said target and formed with substantially axial symmetry with respect to the electron optical axis.

2. The scanning electron microscope and similar apparatus according to claim 1, wherein the surface potential of said target is also maintained at a negative value.

3. The scanning electron microscope and similar apparatus according to claim 1, wherein said detectors each have a cap of a 5 to 20 mm diameter to acquire secondary electrons or reflected electrons.

4. The scanning electron microscope and similar apparatus according to claim 3, further comprising an additional detector above said detectors arranged with axial symmetry.

5. The scanning electron microscope and similar apparatus according to claim 4, further comprising a static electromagnetic field objective lens structure that maintains the sample at a negative potential and includes said objective lens functioning as the retarding electric field.

6. The scanning electron microscope and similar apparatus according to claim 5, further comprising an electrode disposed near the sample to accelerate secondary electrons, the sample being set to assume a grounding potential.

7. The scanning electron microscope and similar apparatus according to claim 1, wherein said detectors each have a cap of a 5 to 20 mm diameter to acquire secondary electrons or reflected electrons.

8. The scanning electron microscope and similar apparatus according to claim 7, further comprising an additional detector above said detectors arranged with axial symmetry.

9. The scanning electron microscope and similar apparatus according to claim 8, further comprising a static electromagnetic field objective lens structure that maintains the sample at a negative potential and includes said objective lens functioning as the retarding electric field.

10. The scanning electron microscope and similar apparatus according to claim 9, further comprising an electrode disposed near the sample to accelerate secondary electrons, the sample being set to assume a grounding potential.

11. The scanning electron microscope and similar apparatus according to claim 1, further comprising an additional detector above said detectors arranged with axial symmetry.

12. The scanning electron microscope and similar apparatus according to claim 11, further comprising a static electromagnetic field objective lens structure that maintains the sample at a negative potential and includes said objective lens functioning as the retarding electric field.

13. The scanning electron microscope and similar apparatus according to claim 11, further comprising an electrode disposed near the sample to accelerate secondary electrons, the sample being set to assume a grounding potential.

14. The scanning electron microscope and similar apparatus according to claims 1, further comprising a static electromagnetic field objective lens structure that maintains the sample at a negative potential and includes said objective lens functioning as the retarding electric field.

15. The scanning electron microscope and similar apparatus according to claims 13, further comprising an electrode disposed near the sample to accelerate secondary electrons, the sample being set to assume grounding potential.
